(19) United States
(12) Patent Application Publication
(10) Pub. No.: US 2025/0252215 A1
(43) Pub. Date: Aug. 7, 2025

(54) PROGRAM FOR AGENT DEVICE

(71) Applicant: Honda Motor Co., Ltd., Tokyo (JP)

(72) Inventors: Takuma Minemura, Tokyo (JP); Kaho Tonomura, Tokyo (JP); Rumi Samukawa, Tokyo (JP); Reima Nishimura, Tokyo (JP)

(21) Appl. No.: 19/042,002

(22) Filed: Jan. 31, 2025

(30) Foreign Application Priority Data
Feb. 1, 2024 (JP) 2024-014365

(51) Int. Cl. G06F 21/62; G06F 40/30

(52) U.S. Cl. CPC G06F 21/6245; G06F 40/30

(57) ABSTRACT

Non-transitory computer-readable recording medium stores program for agent device. Program, when executed by computer constituting agent device, causes computer to execute: input step to receive instruction information from user by voice or touch operation and user information regarding user; recording step to record information including personal information regarding user in storage unit; estimation step to estimate current number of user based on user information; determination step to determine whether personal information stored in storage unit is available based on whether current number of user is singular or plural; determination step to determine output information corresponding to instruction information using information stored in storage unit based on determination result whether personal information is available; and output step to output voice and/or image as output information.

### CROSS-REFERENCE TO RELATED APPLICATION

This application is based upon and claims the benefit of priority from Japanese Patent Application No. 2024-014365 filed on Feb. 1, 2024, the content of which is incorporated herein by reference.

### BACKGROUND OF THE INVENTION

### Field of the Invention

The present invention relates to a program that controls an agent device.

### Description of the Related Art

As this type of technology, with the development of artificial intelligence (AI) technology, a voice assistant service mounted on a smartphone or an agent device in a vehicle has become widespread. In such a voice assistant service, it is possible to enjoy various services such as an operation on a device such as an air conditioner or a lighting connected on a communication network, information search on the Internet, reproduction of music or news, reading of a schedule or a message, and the like.

In general, the voice assistant service is also called a personal voice assistant service, and is assumed to be used by one user. Therefore, in a case where the voice assistant service is used by a plurality of users, security concerns also occur. In response to such a concern, for example, JP 6949149 B2 discloses a technology for setting an access privilege of a new user by introduction of an utterance from a trusted user.

In the conventional technique, access privileges are set to a plurality of users, but it is not assumed that the set plurality of users simultaneously use the service. For example, an incoming message of a certain user may be known to another user. Such a concern is more conspicuous, for example, in a vehicle in which a passenger may get on in addition to the driver.

### SUMMARY OF THE INVENTION

An aspect of the present invention is a non-transitory computer-readable recording medium storing a program for an agent device. The program, when executed by a computer constituting the agent device, causes the computer to execute: an input step to receive instruction information from a user by voice or a touch operation and user information regarding the user; a recording step to record information including personal information regarding the user in a storage unit; an estimation step to estimate a current number of the user based on the user information; a determination step to determine whether the personal information stored in the storage unit is available based on whether the current number of the user is singular or plural; a determination step to determine output information corresponding to the instruction information using the information stored in the storage unit based on a determination result whether the personal information is available; and an output step to output voice and/or an image as the output information.

### BRIEF DESCRIPTION OF THE DRAWINGS

The objects, features, and advantages of the present invention will become clearer from the following description of embodiments in relation to the attached drawings, in which:

FIG. 1 is a schematic diagram illustrating an example of a configuration of an agent system according to an embodiment of the present invention;

FIG. 2A is a diagram illustrating an example of a configuration of a main part of a server device;

FIG. 2B is a diagram illustrating an example of a functional configuration of an assist unit in FIG. 2A;

FIG. 3 is a diagram illustrating an example of personal information ranked; and

FIG. 4 is a flowchart for explaining an example of a processing flow performed by the server device.

### DETAILED DESCRIPTION OF THE INVENTION

### <Overview>

The agent system according to the embodiment interprets the content of the utterance by the service user who uses the agent service using a technology such as voice recognition or natural language processing. Then, an answer to the inquiry input by voice from the service user, execution of a request (voice instruction), and the like are performed. Such an agent system is also referred to as a voice assistant.

In the embodiment, as an example, a communication terminal such as a smartphone that executes an application program (app) for using an agent service and a server device that executes a program for the agent service are linked together to provide the agent service to a service user who uses the communication terminal.

In a case where the agent service is used in an environment where a plurality of service users (users) exists, for example, when one user makes a request to the agent system so as to notify the agent system of an incoming message to the communication terminal of the user, the agent system that has received the request reads out the message, and the content of the message is known to other users. In order to avoid such a situation, the agent system according to the embodiment considers to protect the privacy of the user when using the agent service in an environment where a plurality of users exist.

A configuration of such an agent system will be described in more detail with reference to the drawings.

### <Agent System>

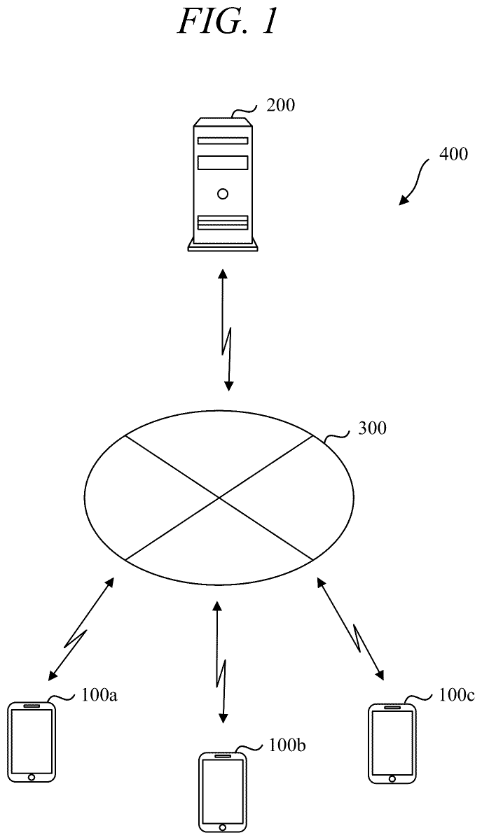

FIG. 1 is a schematic diagram illustrating an example of a configuration of an agent system (voice assist system) 400 according to an embodiment of the present invention. As illustrated in FIG. 1, a voice assist system 400 is configured such that a server device 200 and a plurality of devices 100 can perform data communication via a network 300. The server device 200 is a server device for the voice assist system 400. Further, the device 100 corresponds to a communication terminal used by each user. Although three devices 100a, 100b, and 100c are illustrated as the devices 100 in FIG. 1, the number of devices 100 is large corresponding to the number of users.

The server device 200 executes a program for the voice assist system 400 to perform voice assist in response to an inquiry or a request from each device 100.

Each device 100 executes an application for the voice assist system 400 to transmit an inquiry or a request input by the user by voice to the server device 200 and to execute an operation based on an answer or an instruction transmitted from the server device 200.

The device 100 may include, for example, a smartphone, a phablet, a tablet, a smartwatch, a laptop PC, a desktop PC, an Internet TV, a Home hub, a PDA, a mobile phone, various home appliances, or the like, or may include a voice assistant device or the like mounted on a vehicle.

The network 300 has a function of connecting the server device 200 and the plurality of devices 100 so as to be able to communicate with each other, and is, for example, the Internet, a wired or wireless local area network (LAN), or the like.

In the embodiment, for example, each device 100 records utterance content (voice instruction) of each user, and transmits recorded data to the server device 200 as utterance information of the user. The server device 200 performs voice recognition on the utterance information transmitted from each device 100, interprets an instruction content of the user, and executes voice assistance via the corresponding device 100.

### <Server Device>

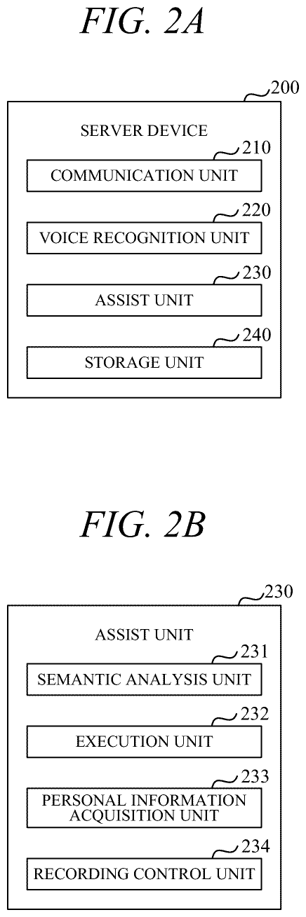

FIG. 2A is a diagram illustrating an example of a configuration of a main part of the server device 200. The server device 200 includes a CPU that performs various calculations, a storage device that stores various data, programs, and the like, and functions as a communication unit 210, a voice recognition unit 220, an assist unit 230, and a storage unit 240.

The communication unit 210 performs data communication with the plurality of devices 100 via the network 300.

The voice recognition unit 220 performs voice recognition on each piece of utterance information from the plurality of devices 100 received via the communication unit 210, thereby converting the utterance information into text data. As an example, the recorded data is acoustically analyzed and converted into text using a voice recognition dictionary, such as an acoustic model, a language model, a pronunciation dictionary, etc.

The assist unit 230 interprets (semantically analyzes) the instruction content from the user on the basis of the converted text data, and executes the assist processing according to the interpreted instruction content.

The storage unit 240 stores, for example, information regarding the user who uses the service of the voice assistant (for example, personal information) for each user. The personal information includes registration information and usage information.

The registration information is information in which a user name (for example, an account as a user identification (ID)) is associated with device information of the device 100 used by the user. The device information may include, for example, a device name (for example, device ID), a model name, an internet protocol (IP) address, and a specification (for example, the output sound pressure level, the frequency characteristics, the crossover frequency, the input impedance, the allowable input, and the like of the speaker as the output device, the screen size, the resolution, and the like of the display as the output device, etc.) thereof.

The usage information is information acquired from the device 100 used by the user when the voice assistant uses the service. For example, the information includes information regarding a social networking service (SNS), a short message service (SMS), and an email used in the device 100 used by the user (including a specific account name or the like followed by the user in the SNS), a keyword used in past search, a history of a destination set in the past, information regarding content subscribed or viewed by Subscription or the like, information on the Internet acquired in the past, setting information for an electronic device such as an air conditioner, an electronic device provided in the vehicle, and the like.

Furthermore, the number of times the user has used the service of the voice assistant (for example, the use frequency per predetermined period) and the information held by the device 100 of the user (for example, an address, a password, and the like of the user) may be included, or the information estimated by the server device 200 from the information regarding the SNS or the like used by the user (for example, a family structure or the like of the user) may be included.

In the embodiment, when the user starts using the service of the voice assistant (at the time of registration), the registration information is recorded in the storage unit 240 of the server device 200 on the basis of the permission of the user. In addition, when the registered user uses the service of the voice assistant, the usage information indicating the use record is recorded in the storage unit 240 of the server device 200. In general, since the usage information increases every time the service is used, the usage information stored in the storage unit 240 may be updated.

### <Use of Personal Information>

The personal information of the user is information having a high degree of confidentiality. In a case where the user receives the service of the voice assistant alone, there is a case where the assist processing convenient for the user can be performed by using the personal information of the user as compared with a case where the personal information is not used at all. However, in a case where one of the users receives the service of the voice assistant in an environment where there are a plurality of users, there is a case where it is inconvenient if personal information of the user is known to other users.

As an example, it is convenient for the user to automatically set the keyword used at the time of the past search by the user for the next search, but there is a case where the keyword is not desired to be known to others. The same applies to the destination set at the time of the past route search by the user.

Furthermore, as another example, there is a case where the content name subscribed by the user is not desired to be known to others although it is convenient for the user to automatically set the content name at the time of the next search.

As still another example, information on the Internet acquired by the user in the past is convenient for the user to be automatically displayed, read, or the like, but may not be desired to be known to others.

In view of the above situation, in the embodiment, the personal information of the user is ranked in five stages, for example, according to the degree of confidentiality. The rank with the highest degree of confidentiality is referred to as level 1, and the rank with the lowest degree of confidentiality is referred to as level 5.

### <Ranks of Personal Information>

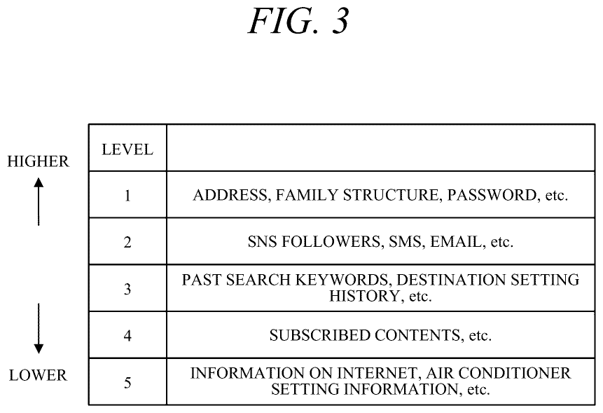

FIG. 3 is a diagram illustrating an example of personal information ranked. When executing the assist processing, the assist unit 230 makes a difference in the rank of the personal information which is available when the personal information is used between a case where the user receives the service of the voice assistant alone and a case where one of the users receives the service of the voice assistant in an environment where there are a plurality of users.

For example, in a case where the user receives the voice assistant service alone, the personal information of the user from level 2 to level 5 is available. On the other hand, in a case where one of the plurality of users receives the service of the voice assistant in the environment where the plurality of users exists, the personal information of the user is made unavailable. This makes it possible to prevent the personal information of the user from being known to other users in an environment where there are a plurality of users. In addition, in a case where the user receives the service of the voice assistant alone, as described above, it is possible to perform the assist processing convenient for the user.

Note that the level of the personal information which is available in a case where the user receives the service of the voice assistant alone is not limited to level 2 to level 5 described above, and may be appropriately changed.

### <Assist Processing>

FIG. 2B is a diagram illustrating an example of a functional configuration of the assist unit 230 in FIG. 2A. The assist unit 230 includes a semantic analysis unit 231, an execution unit 232, a personal information acquisition unit 233, and a recording control unit 234.

The semantic analysis unit 231 performs semantic analysis of instruction contents from the user on the basis of the text data obtained by the voice recognition unit 220.

The execution unit 232 executes assist processing according to the instruction content semantically analyzed by the semantic analysis unit 231. For example, in a case where the instruction content is an inquiry, an answer to the inquiry is determined and generated by a search engine (not illustrated) in the server device 200 or a search server (not illustrated) connected to the network 300. The execution unit 232 transmits the determined or generated answer to the device 100 of the user who has made the inquiry via the communication unit 210 as text information or voice information.

Furthermore, in a case where the instruction content semantically analyzed by the semantic analysis unit 231 is a setting instruction for an electronic device (not illustrated) connected to the network 300, an electronic device provided in a vehicle (not illustrated), or the like, the execution unit 232 determines an operation of outputting a setting instruction signal to the electronic device as a setting target. The execution unit 232 transmits the setting instruction signal to the electronic device as a setting target via the communication unit 210.

Furthermore, in a case where the instruction content semantically analyzed by the semantic analysis unit 231 is an instruction to cause a speaker (or a headphone or the like) to output and play back specific music content, the execution unit 232 determines an operation to play back audio by the speaker (or the headphone or the like) of the device 100 of the user on the basis of music content information stored in the device 100 of the user or a music server (not illustrated) connected to the network 300. The execution unit 232 transmits a signal indicating the storage location and the reproduction instruction of the corresponding music content to the device 100 of the user via the communication unit 210. The audio reproduction may be either streaming reproduction or download reproduction.

As described above, when the user starts using the service of the voice assistant (at the time of registration), the personal information acquisition unit 233 acquires the registration information from the device 100 of the user on the basis of the permission of the user.

In addition, as described above, when the registered user uses the service of the voice assistant, the personal information acquisition unit 233 acquires new usage information from the device 100 of the user.

The recording control unit 234 controls the above-described recording operation of the registration information in the storage unit 240 and the above-described recording operation of the usage information. Furthermore, the recording control unit 234 controls the reading operation of the registration information stored in the storage unit 240 and the reading operation of the usage information stored in the storage unit 240 as necessary.

In the above configuration, the functions of the voice recognition unit 220 and the assist unit 230 can be realized by a CPU (not illustrated) of the server device 200 and a program for the voice assist system 400. The program for the voice assist system 400 is a program for performing voice recognition on recorded data of a user utterance transmitted from a plurality of devices 100 and providing a voice assist service as described above to the user.

### <Description of Flowchart>

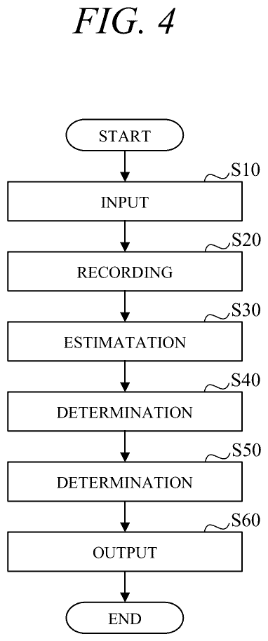

FIG. 4 is a flowchart for explaining an example of a processing flow performed by the server device 200. The CPU of the server device 200 repeatedly executes the processing illustrated in FIG. 4 according to the program for the voice assist system 400.

In S10 (S: processing step) of FIG. 4, the server device 200 performs input step and proceeds to S20. More specifically, the server device 200 inputs, from the device 100 used by the user, position information indicating a current position and instruction information (utterance information) indicating an inquiry or a request input by the user to the device 100 by voice via the communication unit 210.

Note that the user may input an inquiry or a request by a touch operation, a button operation, a key operation, or the like (collectively referred to as a touch operation) on an operation member of the device 100. The instruction information in this case corresponds to text information generated by the device 100 based on the touch operation.

In S20, the server device 200 performs recording step, and proceeds to S30. More specifically, the instruction information transmitted from the device 100 is recorded in a predetermined area (instruction information storage area) of the storage unit 240.

In S30, the server device 200 performs estimation step and proceeds to S40. More specifically, it is estimated whether the number of users is singular or plural on the basis of the position information of each device 100 transmitted from the plurality of devices 100 to the server device 200. In a case where the interval between the plurality of devices 100 of which the position information is input in S10 is within a predetermined distance (for example, about 2 m corresponding to the vehicle interior space), the server device 200 estimates that the number of users is plural. On the other hand, in a case where the interval between the plurality of devices 100 exceeds the predetermined distance or in a case where the number of devices 100 to which the position information is input in S10 is one, the server device 200 estimates that the number of users is singular.

In S40, the server device 200 performs determination step and proceeds to S50. More specifically, based on whether the number of users estimated in S30 is singular or plural, the server device 200 determines that the personal information in the storage unit 240 is available if the number is singular, and determines that the personal information in the storage unit 240 is unavailable if the number is two or more.

In S50, the server device 200 performs determination step and proceeds to S60. More specifically, the assist unit 230 of the server device 200 uses the personal information in the storage unit 240 on the basis of the determination result in S40 to determine output information for the instruction information. Specifically, when the estimated number of users is singular and the instruction content from the user is an inquiry, an answer to the inquiry is determined and generated using the personal information in the storage unit 240. Furthermore, in a case where the estimated number of users is singular and the instruction content from the user is a setting instruction for an electronic device or the like connected to the network 300, the output operation of the setting instruction signal to the electronic device to be set is determined using the personal information in the storage unit 240. Furthermore, in a case where the estimated number of users is singular and the instruction content is an instruction to output and play back specific music content by a headphone or the like, an operation to play back audio is determined using personal information in the storage unit 240.

Conversely, in a case where the estimated number of users is plural, the assist unit 230 of the server device 200 determines output information for each instruction information without using the personal information in the storage unit 240.

In S60, the server device 200 performs output step and ends the process in FIG. 4. More specifically, the server device 200 outputs the output information determined in S50 to the corresponding device 100 via the communication unit 210.

According to the embodiment described above, the following effects are obtained.

(1) The program for the voice assist system 400, the program causing a computer (server device 200) constituting the voice assist system 400 as the agent device to execute: input step (S10) in which instruction information is received from a user by voice or a touch operation and user information regarding the user; recording step (S20) in which information including personal information regarding the user is recorded in the storage unit 240; estimation step (S30) in which the number of users currently using the agent service based on the user information is estimated; determination step (S40) in which whether the personal information in the storage unit 240 is available is determined on the basis of whether the estimated number of users is singular or plural; determination step (S50) in which output information for the instruction information is determined using the information in the storage unit 240 on the basis of a result of the determination; and output step (S60) in which voice and/or an image is output as the determined output information.

With such a configuration, when the service of the voice assistant is used by a plurality of users, it is possible to avoid a situation in which personal information of one user is known to other users and to protect privacy of the user.

(2) In the program of (1), when the number of users estimated by the estimation step (S30) is singular, it is determined in the determination step (S40) that the personal information regarding the user corresponding to the instruction information received by the input step (S10) is available, and the output information for the instruction information is determined in the determination step (S50) using the information including the personal information in the storage unit 240.

With such a configuration, in a case where there the number of users is singular, the assist processing is performed using the personal information of the user, so that it is possible to perform the assist processing more convenient for the single user than in a case where the personal information is not used.

(3) In the program of (1), when the number of users estimated by the estimation step (S30) is plural, it is determined in the determination step (S40) whether the personal information is unavailable or the personal information is available in a predetermined range, and the output information for the instruction information is determined in the determination step (S50) using the information except the personal information in the storage unit 240 or using the personal information in the predetermined range and the information except the personal information in the storage unit 240.

With such a configuration, in a case where the number of users is plural, the personal information of the users is not available, or the assist processing is performed by use with a limited use range. Therefore, it is possible to perform the assist processing convenient for the user while avoiding a situation in which important personal information of one user is known to the other users.

(4) In the program of (3), the user information includes relationship level information indicating the strength of the relationship with the other users, the personal information includes the importance level information indicating the degree of importance for each piece of information, and the predetermined range of the personal information in the storage unit 240 is changed in the determination step (S50) on the basis of the relationship level information and the importance level information.

With such a configuration, the use range of the personal information limited in a case where the number of users is plural can be changed according to the importance of the personal information and the strength of the relationship with the other users.

(5) In the program of (4), the relationship level information indicates the relationship level that increases in the order of acquaintances, friends, and family, and in the determination step (S50), the predetermined range of the personal information is widened as the relationship level of the plurality of users is higher, and the predetermined range is narrowed as the relationship level of the plurality of users is lower.

With such a configuration, it is possible to appropriately change the use range of the personal information limited in a case where the number of users is plural.

(6) In the program of (4), the importance level information indicates a higher importance level as the confidentiality of the personal information is higher, and the predetermined range of the personal information is changed in the determination step (S50) by changing the threshold of the importance level of the personal information used to determine the output information.

With such a configuration, it is possible to appropriately change the use range of the personal information limited in a case where the number of users is plural.

(7) In the program of (1) to (6), the user is an occupant of a vehicle in which the voice assist system 400 is installed, and it is determined in the determination step (S40) whether the personal information in the storage unit 240 is available on the basis of whether the number of occupants estimated in the estimation step (S30) is singular or plural.

With such a configuration, in a vehicle in which a fellow passenger may get on in addition to the driver, it is possible to avoid a situation in which the personal information of one user is known to another user and to protect privacy of the user.

The above-described embodiment can be modified in various manners. Hereinafter, modifications will be described.

### (First Modification)

In the above description, an example has been described in which, in a case where the instruction content from the user is an inquiry, output information for the instruction information is output to the device 100 of the user by voice information (or text information). In a first modification, instead of outputting the voice information as the output information, or together with the voice information as the output information, image information (including a moving image) may be output.

When acquiring the voice information from the server device 200, the device 100 causes a speaker (or a headphone or the like connected in a wired or wireless manner) included in the device 100 to reproduce the output. Furthermore, in a case where the device 100 acquires the image information from the server device 200, the device 100 outputs and reproduces the image information by a display or the like provided in the device.

### (Second Modification)

In the above description, an example in which the server device 200 is configured by one server device has been described, but the server device 200 may be configured using a virtual server function on a cloud or may be configured to be distributed to a plurality of devices.

The above embodiment can be combined as desired with one or more of the aforesaid modifications. The modifications can also be combined with one another.

According to the present invention, it becomes possible to protect privacy of the user when a plurality of users use the agent service.

Above, while the present invention has been described with reference to the preferred embodiments thereof, it will be understood, by those skilled in the art, that various changes and modifications may be made thereto without departing from the scope of the appended claims.

1. A non-transitory computer-readable recording medium storing a program for an agent device, wherein
the program, when executed by a computer constituting the agent device, causes the computer to execute:
an input step to receive instruction information from a user by voice or a touch operation and user information regarding the user;
a recording step to record information including personal information regarding the user in a storage unit;
an estimation step to estimate a current number of the user based on the user information;
a determination step to determine whether the personal information stored in the storage unit is available based on whether the current number of the user is singular or plural;
a determination step to determine output information corresponding to the instruction information using the information stored in the storage unit based on a determination result whether the personal information is available; and
an output step to output voice and/or an image as the output information.

2. The non-transitory computer-readable recording medium according to claim 1, wherein
when it is determined that the current number of the user is singular, it is determined that the personal information is available and the output information is determined using the information including the personal information stored in the storage unit.

3. The non-transitory computer-readable recording medium according to claim 1, wherein
when it is determined that the current number of the user is plural, it is determined that the personal information is unavailable or available in a predetermined range and the output information is determined using the information except the personal information stored in the storage unit or the personal information in the predetermined range and the information except the personal information stored in the storage unit.

4. The non-transitory computer-readable recording medium according to claim 3, wherein
the user information includes relationship level information indicating a strength of relationship between the users, wherein
the personal information includes importance level information indicating a degree of importance of each piece of information, wherein
the predetermined range is changed based on the relationship level information and the importance level information.

5. The non-transitory computer-readable recording medium according to claim 4, wherein
the strength of relationship increases in order of acquaintances, friends, and family, wherein
the predetermined range is widened as the strength of relationship is higher, and the predetermined range is narrowed as the strength of relationship is lower.

6. The non-transitory computer-readable recording medium according to claim 4, wherein
the degree of importance increases as confidentiality of the personal information is higher, wherein
the predetermined range is changed by changing a threshold of the degree of importance of the personal information used to determine the output information.

7. The non-transitory computer-readable recording medium according to claim 1, wherein
the user is an occupant of a vehicle in which the agent device is installed, wherein
it is determined whether the personal information stored in the storage unit is available based on whether the current number of the occupant of the vehicle is singular or plural.

8. The non-transitory computer-readable recording medium according to claim 7, wherein
the user information includes position information indicating a current position of the user, wherein
it is determined that the current number of the user is plural when an interval between the users is within a predetermined distance corresponding to an interior space of the vehicle based on the user information, while it is determined that the current number of the user is singular when the interval exceeds the predetermined distance based on the user information or when a number of the user of whom the user information has been received is singular.
